(19) United States
(12) Patent Application Publication
(10) Pub. No.: US 2026/0071916 A1
(43) Pub. Date: Mar. 12, 2026

(54) NON-CONTACT VARIABLE SENSOR SYSTEM FOR KEY POINT TEMPERATURE EVAULATION IN ANIMALS

(71) Applicant: Zomedica Inc., Ann Arbor, MI (US)

(72) Inventors: Kenneth Balogh, Ann Arbor, MI (US); Vikram Ramprakash, Ann Arbor, MI (US); Austin Wilson, Ann Arbor, MI (US); Scott Ijaz, Ann Arbor, MI (US)

(21) Appl. No.: 19/320,067

(22) Filed: Sep. 5, 2025

Related U.S. Application Data
(60) Provisional application No. 63/691,789, filed on Sep. 6, 2024.

(51) Int. Cl. G01J 5/03; G01J 5/00; G01J 5/08; G01J 5/48

(52) U.S. Cl. CPC G01J 5/03; G01J 5/0025; G01J 5/0859; G01J 5/48; G01J 2005/0077

(57) ABSTRACT

A variable sensor system for non-contact temperature monitoring of animals is described. Non-contact temperature monitoring may involve temperature detection at various key points on an animal. One embodiment of the invention uses key point detection for thermal images for temperature detection. Information obtained from an RGB image of an animal may be overlaid onto a thermal image of the animal to contribute to temperature detection at various key points on the animal.

### CROSS-REFERENCE TO RELATED APPLICATIONS

This non-provisional patent application is based on and claims priority to U.S. Provisional Patent Application Number 63/691,789, filed on Sep. 6, 2024, the disclosure of which is incorporated by reference as if fully recited herein.

### TECHNICAL FIELD OF THE INVENTION

The present invention relates generally to medical systems, and more particularly to a variable sensor system for non-contact temperature monitoring of animals. Non-contact temperature detection may involve detecting a subject's temperature at various key points on the subject. One embodiment of the invention uses key point detection for thermal images for temperature detection.

### BACKGROUND AND SUMMARY OF THE INVENTION

Measurement of a subject's physiological health through temperature monitoring is commonly used, and is useful, in medical diagnostics. Traditionally, animal temperature measurements have been accomplished by direct contact with an animal subject through the use of temperature sensors, primarily hand-held thermometers. For example, veterinarians have tracked the health of animal patients by placing a thermometer directly on one or more of various locations on an animal.

An issue with known techniques for tracking the health of animal patients by monitoring their temperature includes that the direct contact with an animal may make the animal uncomfortable, especially where there are repeated instances of direct contact. Also, in cases where the subject is a potentially aggressive animal, it may not be safe to the medical provider to come in contact with or even come close to the animal. Moreover, in cases where vitals are routinely monitored on a moving object (e.g., a moving animal, such as an animal in a herd), the use of contact sensors may be frustrated by the constant movement. In other instances where a subject animal may be violent, or is contaminated with a pathogen (e.g., a virus) or another substance, being close to the subject may pose a health threat to the medical practitioner.

Another issue with known techniques is that it may be time consuming and/or cumbersome for a veterinarian or other health specialist to employ multiple separate temperature measurements to gather data about the temperature of a subject at various key points (e.g., various points across the face of a subject). An example of why this may be problematic is that the longer an animal undergoes medical testing, the more uncomfortable or distressed the animal may become. Where the subject is a potentially aggressive animal, this may pose a threat to the veterinarian or other health specialist.

The aforementioned shortcomings speak to the need for a system that quickly and remotely obtains and organizes temperature data for a number of key points in a variety of settings. In view of this, it is beneficial to have a non-contact variable sensor system for key point temperature evaluation in animals, and a corresponding method of obtaining and organizing key point temperature information about an animal involving the non-contact variable sensor system.

According to the present invention in one aspect, a first camera and a second camera are provided. The first camera may be configured to capture a first image of an animal. The second camera may be configured to capture a second image of the animal. A processor may be configured to map information from the first image onto the second image to allow for temperature to be evaluated at one or more key points of interest. The first camera may be an RGB imaging device, and the first image may be an RGB image. The second camera may be a thermal imaging device, and the second image may be a thermal image.

Advantages of the present invention, may include, promoting comfort of animal patients, reducing effort required of animal health specialists to gather and organize medical information about animal patients, reducing the length of a veterinary appointment, eliminating dangers to animal health specialists related to getting too close to an animal subject, monitoring mobile subjects in a herd, promoting accuracy of animal health data, and the like.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a non-contact variable sensor system of the present invention involving a first camera and key point detection of thermal images for animal temperature detection;

FIG. 2 illustrates a second camera in use for the system of FIG. 1; and

FIG. 3 illustrates exemplary processor instructions of the system of FIG. 1.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

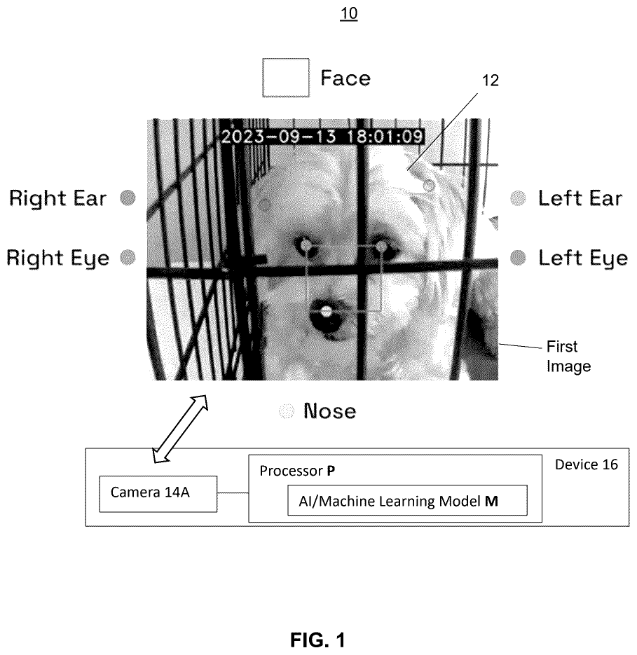

Referring now to FIG. 1, an exemplary non-contact variable sensor system for key point temperature evaluation in animals 10 is shown. The system 10 may be configured to perform temperature detection, temperature data organization, temperature data communication to a user, some combination thereof, or the like steps automatically, in real time. Animal temperature data may be stored in a temporary or permanent database and may be electronically transmitted to a medical chart for an animal, to update a pre-existing chart in the case of a known patient to a veterinarian (or a first chart for the animal may be established in the case of a new patient). Any number of different electronic communication channels may be employed without departing from the scope of the present invention. Furthermore, the present invention is not limited to any particular type of camera, other sensor device, computing device, and/or database software. The system 10 may be integrated into one or more variable sensing devices, such as those described in U.S. Pat. Nos. 7,903,020, 7,848,896, 8,721,554, 8,814,805, 9,200,945, 11,813,043, and U.S. Pat. Pub. No. US20100204587, although such is not required.

An exemplary computing device for the system 10 may have a monitor display that may permit user interaction with an exemplary medical record database (patient record system for various different animals) by way of a system interface. A user may interact with the interface to access medically relevant information about one or more animals. Each data point stored to a patient record system may include a date and time label. The user may be permitted to toggle between different unit types (e.g., metric system versus imperial system/U.S. standard) for certain datasets. Any number of different software modules may be employed to promote user interaction with data stored to a medical record database. Infrared filters and/or other filters may be used with exemplary audio and/or imaging systems to assist in vital sign adjudication (e.g., temperature detection), although such is not required.

One or more algorithms may be implemented as part of the thermal detection system 10 to compare and improve data obtained by the thermal detection system 10. The thermal detection system 10 may be used to determine if an animal or other subject has a fever. Additionally, or alternatively, the thermal detection system may be used to determine if an animal or other subject is present proximate to a sensing device (e.g., by comparing the temperature of the subject to the temperature of the subject's surroundings). Any type and/or number of different sensors (and data acquisition or comparison algorithms related to the sensors) may be provided to analyze subject vitals and/or physiological signals without departing from the scope of the present invention.

Different computing devices of the system 10 may be dedicated to different methods of measurement, although such is not required. A computing system may be configured to operate in parallel or sequentially in regard to reading from various sensors. Collected data may be directed to the processor P for additional processing and/or application of one or more algorithms to be applied on the data/information. To promote real-time display of data measured by the system 10, computing devices linked to and/or integrated with the system 10 may be in electronic communication with any number of different electronic display screens. An exemplary electronic display may display measured, resolved, and/or adjudicated data related to a subject. A computer readable medium may be provided to store an executable sequence of steps, that when executed performs the desired combination of steps. For example, a CPU may be provided to execute a sequential workflow, a GPU may be provided to execute a parallel computing workflow, an FPGA or ASIC may be implemented in hardware, or a hybrid approach such as FPGA+CPU hardware-software co-design implementation.

Referring now to FIGS. 1-3, an exemplary non-contact variable sensor system 10 may involve key point detection of thermal images for animal temperature detection. In this particular embodiment, a first camera 14A of a variable sensor device 16 is configured to capture a first image (an RGB color model—as show in FIG. 1) of an animal 12 (e.g., a dog in a kennel). The device 16 may include a processor P and/or may be in electronic communication with a processor configured to implement software providing a machine learning/artificial intelligence (AI) model M. The software may be implemented using MATLAB, JAVA, CGI script, Python, some combination thereof, or the like. System 10 software may be stored on an electronic storage medium, and may be executed with the cooperation of a controller and memory.

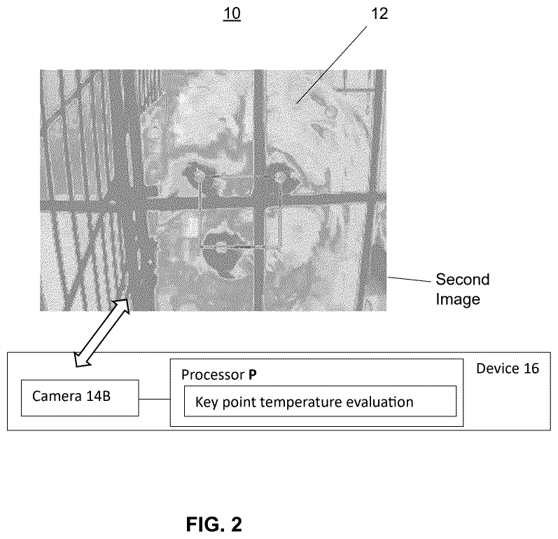

After an RGB color image is captured by the first camera 14A of device 16, the processor P, by way of model M, may be configured to detect and/or identify key points or areas of interest (e.g., face, eyes, ears, nose, some combination thereof, or the like) in the image. A second camera (thermal imaging camera 14B—as shown in FIG. 2) may be configured to capture a second image (a thermal image) of the animal 12. The first and second images may be captured at the same time. The key points or areas of interest captured from the RGB color image may be mapped to the second/thermal image (as shown in FIG. 2). The first and second cameras may provide different image pixels, fields of view, some combination thereof, or the like with respect to one another. An exemplary variable sensor device is not limited to any particular type and/or number of cameras.

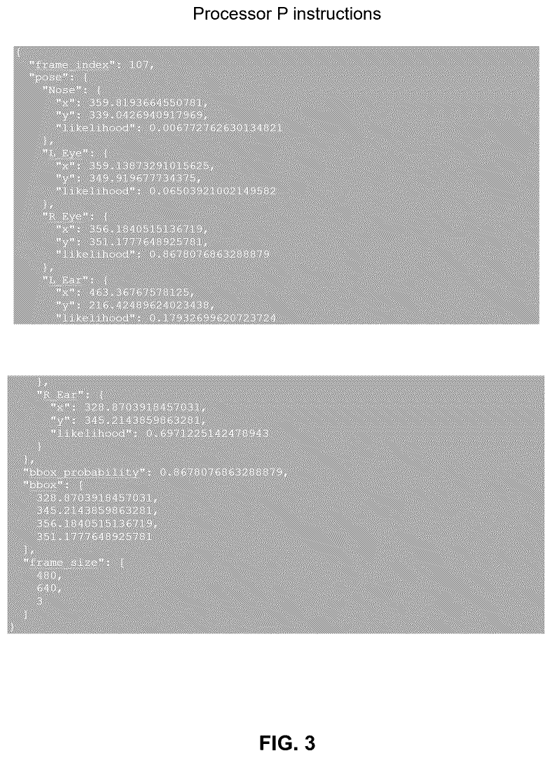

After the second image is mapped with key points or areas of interest identified from the first image, temperature may be extracted from the second/thermal image to determine the temperature for each identified key point/area of interest. As a non-limiting example, where an eye of the animal 12 is detected from the first image (RGB color image), and pixels from the identified eye are mapped to the second image (thermal image), system 10 software may be configured to determine and communicate a temperature of the eye based on thermal image data (e.g., by comparing thermograms from the identified key point in the second image with a temperature known to correspond to the thermograms). Referring to FIG. 3, key points of interest may be output in a text format (e.g., a computer readable format) for conversion and identification of the key points of interest in the thermal image. Probabilities of the features detected may also be provided. Referring to FIG. 2, key points and/or areas of interest may be visually represented on a thermal image, but such is not required.

Advantages of the system 10 include, for example, speed and accuracy of key point detection. Detecting key points or areas from a thermal image (as opposed to an RGB image) is time consuming and not reliable. Key features (e.g., eyes, nose) are generally difficult to detect and identify from a thermal image. Based on this difficulty, known methods for training data on a thermal image are problematic (e.g., there may be inaccuracies with training data, and/or large amounts of data may be required for training, leading to long analysis periods). Known methods for detecting maximum and minimum temperature from a thermal image alone are also problematic because, e.g., various sources of hot or cold objects may negatively impact a temperature evaluation algorithm.

As a non-limiting example, data from an RGB image taken by an RGB camera of a sensing device 16 may be overlaid to a thermal image taken by a thermal imaging camera of the device 16 to permit the processor to evaluate thermograms in an overlaid image to determine temperature of an animal's eye. As another non-limiting example, a camera may track whether any atypical substances are present at and/or discharged from an animal's eye(s). Examples of atypical substances include but are not limited to abnormal ocular discharge and/or foreign material. As another non-limiting example, a camera may track movement of an animal's eye(s) to determine if there are any abnormalities.

The processor P may be provided separate from an exemplary non-contact variable sensor device 16, or may be integrated with the device 16. The device 16 may be positioned over or otherwise proximate to a stall (e.g., a horse stall), crate, or kennel. A transducer may cause transmission and/or receiving of device signals. The information communicated to the processor may be stored in the cloud (e.g., so that the information may be accessed by a computing device at any number of different locations). Information about a subject's eyes stored to the cloud may be communicated to the device 16, an electronic display thereof, or the like. The device 16 may be placed in the range of internet connection to ensure information from the cloud may be communicated to the device 16. Data acquisition and processing related to the subject's eyes may be improved upon by artificial intelligence/machine learning. For example, data about the subject's eyes may be displayed on an electronic display position at the device 16 and/or in electronic communication with the device 16.

Aspects of the system 10 may be communicated and/or displayed to system users and/or administrators by way of any number of different computer readable mediums implemented according to one or more software modules. Software instructions of the system 10 may be executed by the processor P. System 10 software may be implemented using MATLAB, JAVA, CGI script, Python, some combination thereof, or the like. The present invention is not limited to any particular computing and/or display device, nor is it limited to any particular shape, size, component arrangement and/or design. The present invention is further not limited to the use of an exemplary cloud module with only eye information. An exemplary cloud module may be used to store and communicate information about any number of different features of a subject.

The system 10 may include a transmitter configured to transmit data from a non-contact variable sensor to a medical record database. Medically useful information may be detected by an exemplary sensor automatically, and may be communicated to a medical record database automatically (by way of a processor linked to a sensor of a sensing device). Any embodiment described herein may include a processor configured to communicate (e.g., by way of a Bluetooth signal) medically useful information detected by a non-contact variable sensor to an interface of a software application.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. Although embodiments described herein were described with reference to obtaining and organizing medical information about an animal, it will be apparent to one of ordinary skill in the art that an exemplary embodiment of the present invention may also be useful for other purposes.

Any embodiment of the present invention may include any of the features of the other embodiments of the present invention. Furthermore, certain operations described herein may be performed by one or more electronic devices. Each electronic device may comprise one or more processors, electronic storage devices, executable software instructions, and the like configured to perform the operations described herein. The electronic devices may be general purpose computers or specialized computing devices. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A medical examination system for animals, comprising:
a non-contact variable sensor, comprising a first camera and a second camera;
a processor, in association with said non-contact variable sensor;
wherein said first camera is configured to capture a first image of an animal;
wherein said second camera is configured to capture a second image of said animal; and
wherein said processor is configured to map information from said first image onto said second image to allow for temperature to be evaluated at one or more key points of interest.

2. The system of claim 1, wherein said first camera is an RGB imaging device, and said first image is an RGB image.

3. The system of claim 2, wherein said second camera is a thermal imaging device, and said second image is a thermal image.

4. The system of claim 1, wherein at least one of said one or more key points of interest is located at a face of said animal.

5. The system of claim 4, wherein at least one of said one or more key points of interest is located at an eye of said animal.

6. The system of claim 5, wherein at least one camera of said first and second cameras is configured to evaluate whether any atypical substances are present at said eye of the animal.

7. The system of claim 1, wherein said processor is configured to output key point of interest data in a text format.

8. A medical examination system for animals, comprising:
a non-contact variable sensing device comprising a first camera configured to capture a first image of an animal, and a second camera configured to capture a second image of said animal, wherein said second image is a thermal image; and
a processor operatively associated with said sensing device, said processor configured to:
identify one or more key points of interest from said first image;
map said one or more key points of interest from said first image onto said second image; and
determine a temperature value for at least one of said one or more key points of interest.

9. The system of claim 8, wherein said first camera is an RGB camera, said second camera is a thermal imaging device, and said first image is an RGB image.

10. The system of claim 9, wherein at least one of said one or more key points of interest is located at a face of said animal.

11. The system of claim 10, wherein at least one of said one or more key points of interest is located at an eye of said animal.

12. The system of claim 11, wherein at least one camera of said first and second cameras is configured to evaluate whether any atypical substances are present at said eye of said animal.

13. The system of claim 8, wherein said processor is configured to store said temperature value in a database.

14. The system of claim 13, wherein said database is cloud-based, and accessible by a remote computing device.

15. The system of claim 8, wherein said processor is further configured to determine when said animal is present proximate to said sensing device based on said temperature value.
